(19) United States
(12) Patent Application Publication
(10) Pub. No.: US 2008/0059300 A1
(43) Pub. Date: Mar. 6, 2008

(54) Targeting an ad to a mobile device

(75) Inventor: Omar Hamoui, Palo Alto, CA (US)

Correspondence Address: VAN PELT, YI & JAMES LLP, 10050 N. FOOTHILL BLVD #200, CUPERTINO, CA, 95014, US

(73) Assignee: AdMob, Inc.

(21) Appl. No.: 11/702,958

(22) Filed: Feb. 6, 2007

Related U.S. Application Data
(60) Provisional application No. 60/841,696, filed on Sep. 1, 2006.

(51) Int. Cl. G06Q 30/00

(52) U.S. Cl. 705/14

(57) ABSTRACT

Various techniques for improving the delivery of mobile ads to devices are disclosed herein. For example, ads are matched with parameters passed to an ad source and then delivered to a publisher to be included with downloaded content. Ads may be targeted to specific devices is specified by an advertiser. Targeting information may be gathered from the device and from information previously provided to the publisher. Fees are assessed base on the degree of targeting. These and other improvements are described in detail.

### CROSS REFERENCE TO OTHER APPLICATIONS

This application claims priority to U.S. Provisional Patent Application No. 60/841,696 entitled “Delivering Ads to Mobile Devices” filed Sep. 1, 2006, which is incorporated herein by reference for all purposes.

### BACKGROUND OF THE INVENTION

Techniques for providing ads with web sites and web pages exist. In such cases, for example, the content of an ad provided with a web site may be related to the content of the web site. Such techniques, however, are not optimal for providing ads with content accessed by mobile devices. It would be useful for advertisers to more directly target ads to different types of mobile devices and different types of users of mobile devices.

Thus, there is a need for an improved paradigm to deliver ads to mobile devices.

### BRIEF DESCRIPTION OF THE DRAWINGS

Various embodiments of the invention are disclosed in the following detailed description and the accompanying drawings.

FIG. 1 illustrates an embodiment of a network environment in which an ad is delivered to a mobile device.

FIG. 2 illustrates an embodiment of a process for obtaining content at a mobile device.

FIG. 3 illustrates an embodiment of a process for providing an ad with requested content to a mobile device.

FIG. 4 illustrates an embodiment of a process for providing an ad to a publisher.

FIG. 5 illustrates an embodiment of a process for obtaining a bid for an ad from an advertiser.

FIG. 6 illustrates an embodiment of a process for selecting a winning ad.

FIG. 7 illustrates an embodiment of a process for receiving a click on an ad provided by an ad provider.

FIG. 8 illustrates an embodiment of a process for assessing a targeting fee for an ad.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention. encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Various techniques for improving the delivery of mobile ads to devices are disclosed herein. For example, ads are matched with parameters passed to an ad source and then delivered to a publisher to be included with downloaded content. Ads may be targeted to specific devices as specified by an advertiser. Targeting information may be gathered from the device and from information previously provided to the publisher. Fees are assessed base on the degree of targeting. These and other improvements are described in detail below.

An advertisement (ad) from an advertiser is published by a publisher of the ad. A publisher may provide an ad with other content associated with or available from the publisher. For example, a publisher of content may correspond to a web site or web page that includes with the content of the web site or web page one or more ads. A publisher may correspond to any appropriate application, program, or platform that provides ads. The subject of an ad may be related to content from the publisher. In some embodiments, a publisher receives one or more ads for publishing from an ad provider that represents one or more advertisers and distributes ads to one or more publishers.

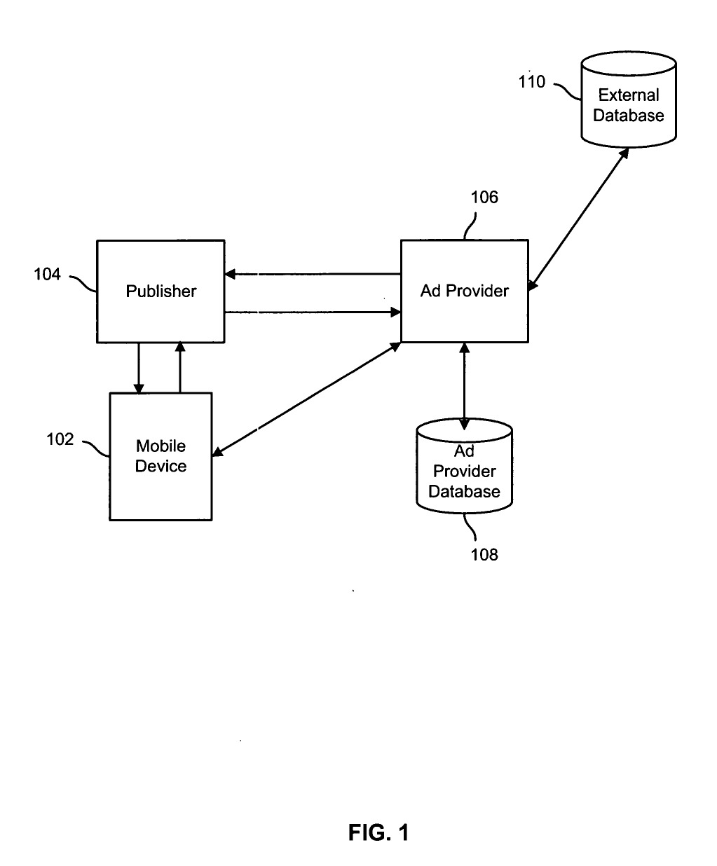

FIG. 1 illustrates an embodiment of a network environment in which an ad is delivered to a mobile device. A user of a mobile device 102, such as a cellular telephone or personal digital assistant, may desire to access content associated with a publisher 104, such as a mobile web server. When mobile device 102 requests content from publisher 104, publisher 104 in response provides the requested content as well as one or more ads. The ads may be related to the requested content and/or targeted to mobile device 102 or the user of mobile device 102. Wireless application protocol (WAP) or any other appropriate method is employed for communication between mobile device 102 and publisher 104.

As depicted in the example of FIG. 1, one or more ads may be received by publisher 104 from an ad provider 106 in response to a request by publisher 104 for one or more ads. Ad provider 106 provides ad provisioning services to publishers of ads on behalf of advertisers and may have various business agreements with advertisers to distribute their ads to publishers. Ad provider database 108 includes ads available at ad provider 106 for distribution to publishers. As described further below, in some embodiments, information about mobile device 102, the user of mobile device 102, and/or the content requested by mobile device 102 is provided by publisher 104 to ad provider 106 when requesting one or more ads so that more targeted ads can be supplied by ad provider 106 to publisher 104 for delivery to mobile device 102 with the requested content.

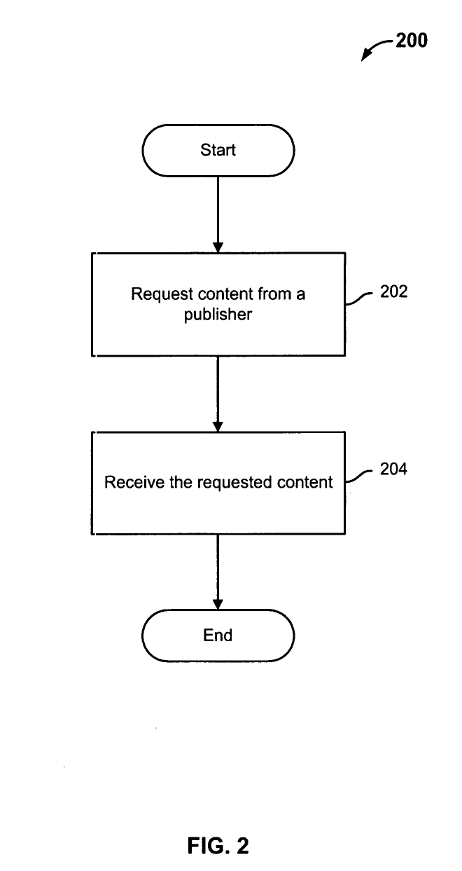

FIG. 2 illustrates an embodiment of a process for obtaining content at a mobile device. With respect to FIG. 1, for example, process 200 may be employed by a mobile device 102 to request and receive content from a publisher 104. Process 200 starts at 202 at which content is requested from a publisher of the content. In some embodiments, 202 includes establishing a communication session between a mobile device and a publisher. At 204, the requested content is received from the publisher, and process 200 subsequently ends. In some embodiments, one or more ads are received with the requested content at 204 from the publisher.

As depicted in the example of FIG. 1, a publisher may dynamically obtain ads from an ad provider. In some embodiments, the publisher is provided by the ad provider with a self-contained module of code (sometimes referred to herein as an “ad procurement module”) for dynamically obtaining an ad from the ad provider. The ad procurement module and/or function calls to the ad procurement module may be embedded at the publisher at places where ads are desired to be included or published with respect to content from the publisher. For example, the ad procurement module or a function call to the ad procurement module may be embedded by the publisher at the point in the source code of a web page or web site at which the publisher desires to include or display an ad. If an ad procurement module is associated with content requested by a mobile device, the ad procurement module is dynamically invoked at the publisher to obtain from the ad provider an ad so that it can be delivered to the mobile device with the requested content.

In some embodiments, user characteristics associated with a mobile device requesting content with respect to which an ad procurement module is invoked are included as parameters with a request for an ad to the ad provider so that a more relevant and targeted ad can be selected at the ad provider. As described further below, user characteristics that may be available at a publisher include characteristics associated with the hardware and/or software of the mobile device, characteristics associated with the user of the mobile device, characteristics associated with the requested content, etc. In some embodiments, an ad procurement module at a publisher performs the processing associated with obtaining user characteristics from the publisher to be included in a request for an ad, requesting an ad from the ad provider, and receiving an ad from the ad provider.

In some embodiments, different flavors or versions of the ad procurement module in different languages or implementations, such as PHP, JSP, ASP, CGI, etc., are available from the ad provider so that one or more versions that are compatible with the languages or platforms employed by a publisher can be provided to the publisher. The functionality associated with the various versions of the ad procurement module is generic regardless of the language in which it is implemented. For example, an ad procurement module may obtain at the publisher the same set of parameters to be included in a request for an id regardless of the implementation and/or platform of the publisher and the version of the ad procurement module.

In some embodiments, the set of information obtained by an ad procurement module at a publisher to be included in a request for an ad to an ad provider includes the IP address and the user agent associated with the mobile device requesting content with respect to which the ad procurement module is invoked. The user agent is a device identifier that identifies the type (i.e. hardware and/or software platform) of a mobile device and is the same for all devices of the same type. In some embodiments, the set of information obtained by an ad procurement module includes the IMEI (International Mobile Equipment Identity) number associated with a mobile device. In some embodiments, the set of information obtained by an ad procurement module includes an identifier associated with the requested content. For example, a site identifier may be obtained by an ad procurement module when the requested content comprises a particular web site or web page. The set of information may be available at a publisher via a communication session between the publisher and a mobile device. For example, the set of information may be extracted at a publisher from a request for content from a mobile device. In some embodiments, an ad procurement module is configured to obtain when invoked a prescribed standard set of information if available (e.g., IP address, user agent, site identifier, etc.) and include the set of information in a request for an ad to an ad provider.

User specific information may be provided from a publisher to an ad provider when requesting an ad. For example, if any specific information about a user of a mobile device requesting content from a publisher exists at the publisher, the publisher can provide at least some such information to an ad provider so that a more targeted ad can be selected by the ad provider based on the information. User specific information may be provided by a publisher instead of and/or in addition to a prescribed standard set of information, such as the IP address, user agent, site identifier, etc., and may vary for different publishers depending on the type of user specific information available at a publisher. For example, in order to access content from a publisher, a user might need to create a user account which might include demographic information about the user such as name, age, gender, ethnicity, address, phone number, email address, time zone, location, etc. A publisher may maintain with respect to a user account a history of the user's activity with respect to the publisher from which information about a user's interests or potential interests may be deduced and provided to an ad provider. In the cases in which a user logs in. to a user account to access content from a publisher, the publisher can retrieve pieces. of information available from and/or associated with the user account and provide such information to an ad provider so that a more relevant ad can be provided to the user with the desired content. However, user specific information may be abstracted when provided to an ad provider in order to protect the confidentiality of the user. For example, information such as a user is a male, in age group 18-25, and in zip code 94305 may be provided by a publisher to an ad provider instead of specific information such as the name of the user, the actual age, and the full address.

In some embodiments, a request for content from a mobile device includes user specific information, arid such information may be available at a publisher via the request from the mobile device. For example, the phone number and/or IMEI number of a mobile device may be available at a publisher from a communication session with the mobile device. Other user specific information such as the carrier of the mobile device, the location of the mobile dc vice, etc., may be available at the publisher. In some embodiments, a publisher might have a deal with the carrier providing service to a mobile device and may obtain user specific information from the carrier. Since the availabilities of and manners of storing various types of user specific information vary among different publishers, user specific information may be provided by a publisher to an ad provider via an API rather than via an ad procurement module that is employed to provide to the ad provider a prescribed standard set of information (e.g., the IP address, user agent, site identifier, etc.) that can be obtained in a known manner at all or at least most publishers. In some embodiments, an ad procurement module includes code that facilitates look-up of user specific information at a publisher and includes any such information retrieved from the publisher with a request for an ad, for example, by concatenating such information to the prescribed standard set of information in an ad request.

In some embodiments, an ad request to an ad provider from a publisher is in the form of a URL to an ad server associated with the ad provider. In some embodiments, an ad request to an ad provider from a publisher is in the form of an HTTP GET request. In some embodiments, an ad provider has deals with various carriers to directly obtain user specific information from the associated carriers at the ad provider-side from the parameters or information supplied by a publisher in an ad request. Based at least in part on the information provided to an ad provider by a publisher and/or obtained by the ad provider, an ad is selected and provided to the publisher by the ad provider so that the ad can be provided to a mobile device with requested content. In some embodiments, multiple ads are requested from and provided by an ad provider to a publisher and, in turn, to a mobile device. An ad may include any appropriate type of multimedia content, such as text, banners, images, graphics, animation, sound, video, etc., and the type of ad provided to a particular mobile device may be based on the types of content that can be supported by the mobile device. In some embodiments, an ad includes a clickable URL, e.g. to a web page or web site of an associated advertiser. In some embodiments, an ad includes a phone number or a link to a phone number associated with an advertiser that can be clicked on and dialed at a mobile device (i.e. click-to-call).

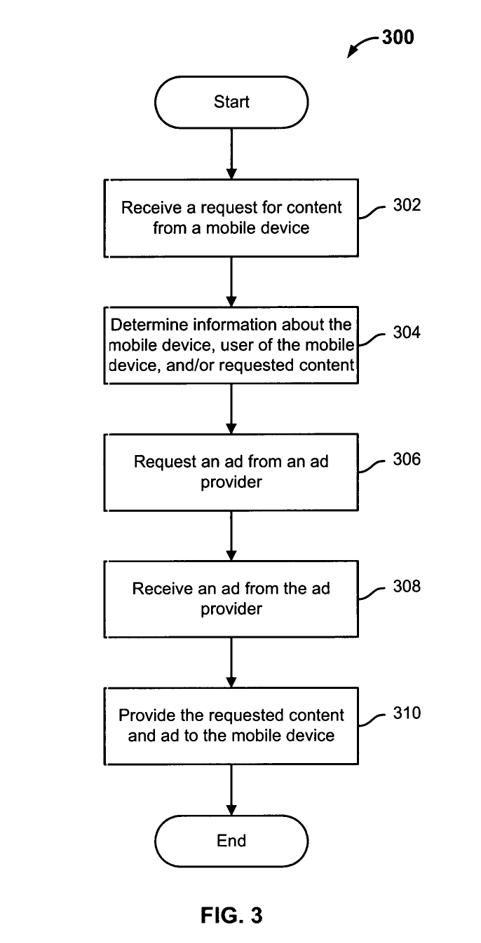

FIG. 3 illustrates an embodiment of a process for providing an ad with requested content to a mobile device. With respect to FIG. 1, for example, process 300 may be employed by a publisher 104 to provide an ad obtained from an ad provider 106 with requested content available from publisher 104 to a mobile device 102. Process 300 starts at 302 at which a request for content is received from a mobile device. The requested content may correspond to, for example, a web site or web page available or accessible from the publisher. At 304, information associated with the mobile device, user of the mobile device, and/or requested content is determined. In some embodiments, the information determined at 304 comprises a prescribed standard set of information, if available, such as the IP address of the mobile device, user agent of the mobile device, an identifier associated with the requested content, etc. In some embodiments, the information determined at 304 includes information such as the phone number of the mobile device, the IMEI number of the mobile device, the carrier of the mobile device, the location of the mobile device, information about a user of the mobile device, etc.

The information of 304 may be determined, for example, from a communication session between the mobile device and the publisher, from the request for content received from the mobile device at 302, from a user account of a user of the mobile device, from a carrier of the mobile device, etc. In some embodiments, at least some of the information of 304 is determined at a publisher by an ad procurement module. At 306, an ad is requested from an ad provider. In some embodiments, the request for an ad at 306 includes the information determined at 304 so that a more relevant or targeted ad can be selected by the ad provider. In some embodiments, at least some of the information determined at 304 is provided to the ad provider with the ad request via a dedicated API. In some embodiments, the request for an ad is made at 306 by an ad procurement module at the publisher. At 308, an ad is received from the ad provider. In some embodiments, the ad is received from the ad provider at 308 by the ad procurement module. At 310, the requested content as well as the ad received at 308 are provided to the requesting mobile device, and process 300 subsequently ends. Although process 300 is described with respect to obtaining from an ad provider and providing to a mobile device a single ad, process 300 can be similarly employed for obtaining and providing multiple ads.

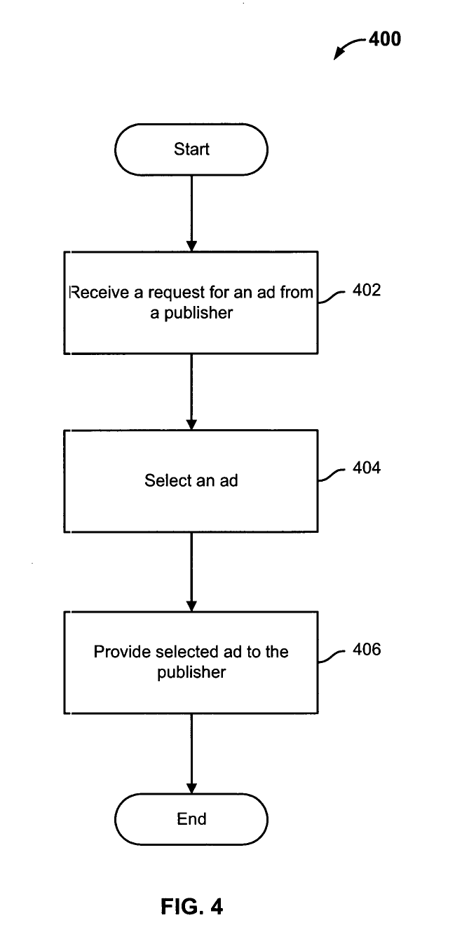

FIG. 4 illustrates an embodiment of a process for providing an ad to a publisher. With respect to FIG. 1, for example, process 400 may be employed by an ad provider 106 to provide an ad to a publisher 104. Process 400 starts at 402 at which a request for an ad is received from a publisher. In some embodiments, the request received at 402 includes information associated with a mobile device requesting content from the publisher and to which the publisher desires to provide an ad with the requested content. Depending on the information available at a publisher, the request for an ad received at 402 may include information associated with the mobile device, a user of the mobile device, content requested by the mobile device, etc. A request for an ad may include, for example, the IP address of the mobile device, the user agent of the mobile device, information about the content requested by the mobile device, the phone number of the mobile device, the IMEI number of the mobile device, the carrier of the mobile device, the location of the mobile device, information about a user of the mobile device, etc. In some embodiments, at least a prescribed standard set of information, such as the IP address of the mobile device, the user agent of the mobile device, information about the content requested by the mobile device (e.g., a site identifier), etc., is included in a request for an ad if available at the publisher so that a more relevant or targeted ad can be selected for the mobile device by the ad provider. In some embodiments, at least some of the information received with a request for an ad at 402 is received via a dedicated API. In some embodiments, the request for an ad is received at 402 from an ad procurement module at the publisher.

At 404, an ad is selected from a set of available ads in response to the request of 402. In some embodiments, an ad is selected at 404 based at least in part on the information included with the request for an ad received at 402. The information included with the request for an ad may be matched against targeting parameters associated with ads available at the ad provider to obtain a pool of matching ads. The targeting parameters for each ad are specified by an associated advertiser in a bid or contract with the ad provider to distribute the ad for publication. A winning ad is selected at 404 from the pool of matching ads based on an algorithm that takes into consideration factors such as the bid amount of each ad (that an associated advertiser would pay, for example, each time the ad is published, clicked on, etc.), the popularity of each ad (e.g., as determined by the number of times the ad has been clicked on over a prescribed period of time), the number of times each ad has been provided to a publisher for publication over a prescribed period of time, etc. At 406, the ad selected at 404 is provided to the publisher from which the request for an ad was received at 402 for publication, and process 400 ends. In some embodiments, the ad is provided at 406 to the ad procurement module of the publisher. Although process 400 is described with respect to providing a single ad to a publisher, process 400 can be similarly employed for providing a plurality of ads to a publisher.

A collection of ads are available at an ad provider for distribution to publishers. An ad is provided to an ad provider by an advertiser for distribution for publication. The ad provider allows advertisers to place bids on ads, and the ad provider facilitates the distribution of the ads to publishers, for example, based at least in part on various targeting information specified by the advertisers of the ads. In some embodiments, a bid for an ad made to an ad provider by an advertiser is associated with a site identifier, an ad identifier, and/or a bid amount. The site identifier of a bid may specify one or more sites and/or one or more channels. It may be desirable for an advertiser to publish an ad on one or more target sites or types of sites, for example, because the content of the sites and ad are related in some manner. In various embodiments, the site identifier specifies one or more specific sites or types of sites or channels on which to publish an ad. As used herein, the term “channel” refers to a group or aggregate of sites having a common theme. Examples of channel categories include entertainment, sports, news, download, portals, communities, contextual search, etc. An advertiser for a movie, for instance, may desire to publish an ad for the movie on an entertainment channel, which includes a plurality of entertainment sites.

The ad identifier of a bid is associated with a particular ad as well as targeting information associated with the ad. In some embodiments, an advertiser is presented by the ad provider with a targeting tree to select targeting parameters for an ad so that the ad can be delivered by the ad provider to the types of users desired by the advertiser. Targeting parameters that may be specified by an advertiser include, for example, target geographic locations (e.g., North America, South America, Europe, Asia, etc., which may be more finely divided such as into countries, states, cities, etc.), target manufacturers and/or model, of mobile devices (e.g., Nokia, Samsung, Motorola, Palm, etc.), target platforms of mobile devices (e.g. Windows Mobile, Palm, MIDP 1.0, MIDP 2.0, etc.), target carriers of mobile devices (e.g., Sprint, Cingular, etc.), target capabilities of mobile devices (e.g., support for polyphonic ring tones, support for streaming video, support for downloadable video, etc.), target demographic information (e.g., gender, age bracket, location, etc., of the user), etc. Depending on the extent of targeting desired by an advertiser, one or more of such targeting parameters may be specified by the advertiser for an ad. For example, an advertiser may target a particular ad to Nokia users on MIDP 2.0 devices in Europe that have polyphonic ring tone support. The targeting of ads is part of the ad bidding or ad specification by an advertiser, and advertisers compete against one another for the publication of their ads only when they have the same or similar targeting. For example, an advertiser targeting an entertainment channel in Europe does not compete with an advertiser targeting the same entertainment channel in North America.

The bid amount is a fee charged to the advertiser of an ad by the ad provider, for example, each time the ad is clicked and may be shared with the publisher of the ad. As described further below, the frequency of selecting an ad for publication by the ad provider may depend at least in part upon the bid amount of the ad.

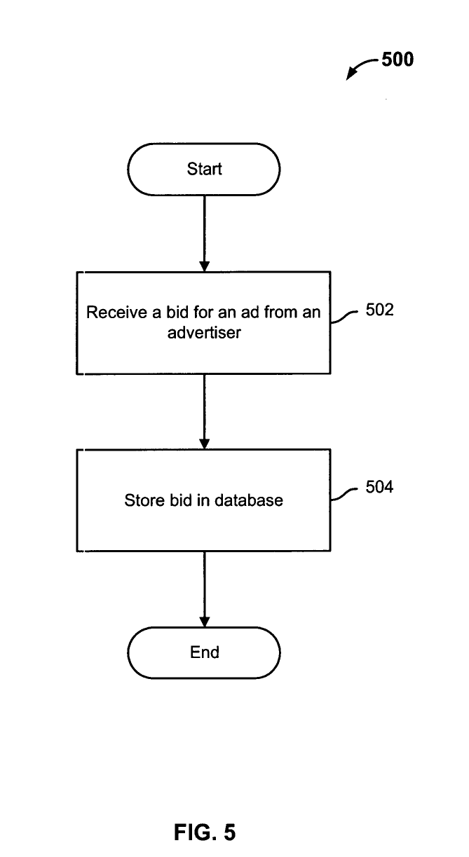

FIG. 5 illustrates an embodiment of a process for obtaining a bid for an ad from an advertiser. With respect to FIG. 1, for example, process 500 may be employed at an ad provider 106. Process 500 starts at 502 at which a bid for an ad is received from an advertiser. The bid for an ad may be associated with various information, such as a site identifier that identifies one or more sites or channels on which to publish the ad, an ad identifier that identifies the ad and any targeting parameters specified by the advertiser, a bid amount that specifies the fee to be paid by the advertiser, for example, each time the ad is clicked, etc. At 504, the bid is stored at the ad provider, and the associated ad is available for distribution for publication. For example, with respect to FIG. 1, the bid may be stored in a database 108 at ad provider 106. Process 500 subsequently ends.

As described above, a set of information associated with a mobile device requesting content from a publisher may be provided by the publisher to an ad provider with a request for an ad. In the cases in which the IP address of a mobile device is provided with an ad request to an ad provider, the IP address may be mapped at the ad provider to a geographical region (e.g., continent, country, state, city, etc.) and/or a carrier. For example, a GEOIP library may be employed to map the IP address to a geographical region. Similarly, a dedicated library may be employed to map the IP address to a carrier. In some cases, the carrier mapping is a subset of the region mapping. For example, an IP address may be mapped to North America Cingular or North America Sprint.

In the cases in which the user agent of a mobile device is provided with an ad request to an ad provider. the user agent may be mapped at the ad provider into a device description, which may include information such as the manufacturer and/or model of the mobile device, platform of the mobile device, capabilities of the mobile device, features that the mobile device can support, etc. For example, a UAPROF and/or WURFL library may be employed for mapping the user agent into a device description. In some such cases, only device description parameters that are relevant for targeting are retrieved via such as mapping.

In various embodiments, libraries to perform look-ups or mappings for parameters such as the IP address and the user agent of a mobile device may exist internally at the ad provider, e.g., in an associated database such as database 108 of FIG. 1, or may be accessed externally, e.g., via a network connection to an external database such as database 110 of FIG. 1. In some embodiments, if a particular user agent value does not exist in an internal library or database (e.g. 108 of FIG. 1) used to perform the user agent look-up for a device description, the user agent value is flagged or marked so that the user agent value can be manually identified with a device description and the associated library can be expanded with the user agent value so that in the future that user agent value is known at the ad provider.

In some embodiments, an identifier associated with the content requested by a mobile device from a publisher is provided to an ad provider by the publisher with a request for an ad for the mobile device. For example, a site identifier that identifies a requested site and/or a channel to which a requested site belongs may be provided to the ad provider with an ad request. In some embodiments, a site identifier that identifies a specific site or type of site (or any other kind of content identifier associated with the requested content and provided with the ad request) is mapped at the ad provider to a particular channel or category of sites. The content identifier provided with an ad request and/or an associated site or channel can be matched at the ad provider against the site identifiers specified by the advertisers in their bids for ads to obtain a group of matching ads (or bids) from the set of ads (or bids) available at the ad provider. Such a matching may be performed at the ad provider, for example, via a look-up in a database in which bids for ads are stored, such as database 108 of FIG. 1. The group of matching ads corresponds to the ads available at the ad provider whose bids are associated with a site identifier that is the same as similar to, or associated with a site or other content identifier provided with an ad request.

Upon identifying such a group of matching ads based on site identifiers, other information associated with the mobile device for which an ad is to be provided that is included with an ad request may be matched against targeting parameters associated with each of the ads in the group of matching ads to filter the group of matching ads. For example, information associated with the geographic region, carrier, and/or device description of the mobile device which can be determined at the ad provider from the IP address and/or user agent of the mobile device provided with an ad request may be compared against corresponding targeting parameters specified for the ads included in the group of matching ads if available. For instance, if an ad in the group of matching ads is targeted for Asia but the geographic region associated with the mobile device as determined from its IP address is North America, the ad targeted for Asia is filtered out from the group of matching ads. Other information such as demographic information that is supplied by a publisher with an ad request may be similarly matched against corresponding targeting parameters of the ads, if available, to further filter the ads.

In some embodiments, one or more targeting parameters associated with an ad may be sequentially or hierarchically compared with corresponding parameters associated with a mobile device if such corresponding parameters are included with an ad request. For example, if the site identifier associated with the content requested by a mobile device matches the site identifier associated with a bid for an ad, the geographic region or location of the mobile device is matched with the geographic region associated with the bid for the ad; if the geographic region matches, the carrier is matched; if the carrier matches, one or more parameters associated with the device description are matched; and so on. Depending on the degree of targeting available for each ad, one or more targeting parameters associated with each ad available at the ad provider are matched in an appropriate order with corresponding parameters associated with a mobile device if such corresponding parameters are included with an ad request. Different targeting parameters or different granularities of targeting parameters may be matched for different ads available at the ad provider depending on the targeting specified by the associated advertisers. If at any step a targeting parameter associated with an ad does not match a corresponding parameter included with an ad request, the ad may be eliminated or filtered out from the group of matching ads. If the targeting parameters of an ad match corresponding parameters associated with the mobile device for which an ad is to be selected, the ad remains in the group of matching ads.

Once a final group of matching ads has been obtained after matching various parameters and filtering, a single ad is selected as the winning ad from the final group and provided to the publisher. In some embodiments, in order to select a winning ad, each ad in the final group of matching ads is weighted and an algorithm is employed to randomly select an ad from the final group of matching ads based on the weightings of the ads. In some embodiments, each ad in the final group of matching ads is weighted at least in part by its associated bid amount. In some such cases, for example, if two ads exist in the final group of matching ads with one having a bid price of $0.10 and the other having a bid price of $0.05, the ad with the bid price of $0.10 is selected for publication twice as many times as the ad with bid price $0.05. With such a scheme, an advertiser having a higher bid has a higher probability of having an associated ad published. The weighting and selection algorithm can be defined as appropriate. For example, in addition to and/or instead of being based on the bid amount, the weighting associated with an ad may be based at least in part on the popularity of the ad which can be measured, for example, by the number of times the ad has been clicked over a prescribed window of time or cumulatively in the past. With such a scheme, for example, if an advertiser has bid $0.10 for an ad but the ad represents only 1% of clicked ads whereas a different ad from another advertiser that has a bid amount of $0.08 represents 20% of clicked ads, the $0.08 ad is selected for publication more frequently. Other factors, such as the number of times a particular ad has been selected over a prescribed window of time, may also affect the weighting of an ad. Based on the weightings of the ads in the final group of matching ads and an associated algorithm for selecting an ad, a winning ad is selected and provided to the publisher.

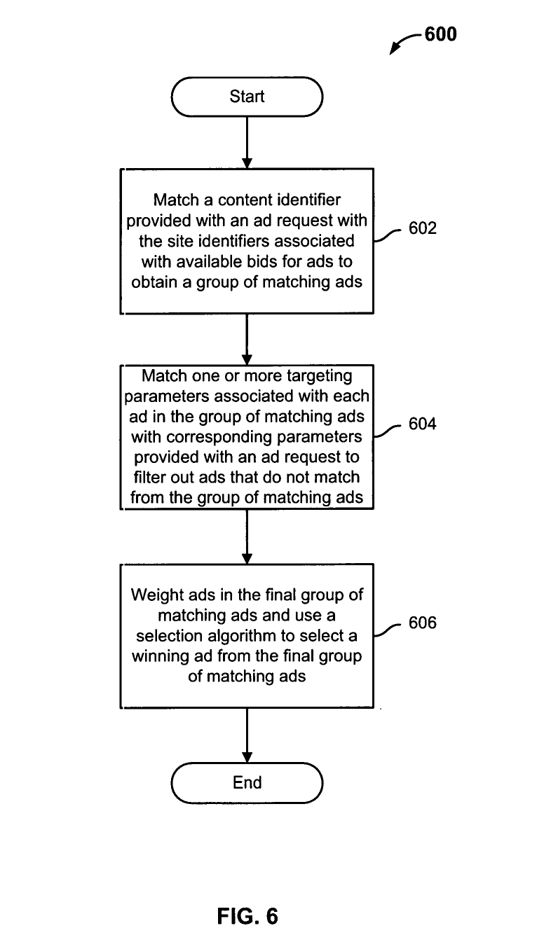

FIG. 6 illustrates an embodiment of a process for selecting a winning ad. With respect to FIG. 1, for example, process 600 may be employed at ad provider 106. In some embodiments, process 600 is employed at 404 of process 400 of FIG. 4 to select an ad. Process 600 starts at 602 at which a content identifier provided with an ad request is matched against the site identifiers associated with available bids for ads to obtain a group of matching ads. The content identifier provided with an ad request identifies the content requested by a mobile device for which an ad is to be selected and may identify or be associated with a particular site, type of site, channel, etc. At 604, one or more other targeting parameters associated with each ad in the group of matching ads are matched with corresponding parameters of a mobile device for which an ad is to be selected if such corresponding parameters are provided with an ad request in order to filter out ads that do not match from the group of matching ads. The targeting parameters of 604 may be associated with a target geographic region, carrier, device description, demographic information, etc. The ads remaining in the final group of matching ads are weighted, and a selection algorithm is employed to select a winning ad from the final group of matching ads at 606. In various embodiments, the weighting of each ad at 606 is based at least in part on one or more of the bid amount of the ad, the popularity of the ad, the number of times the ad has been published over a prescribed window of time, etc. Process 600 subsequently ends.

In some embodiments, an ad provider includes a personalization engine that allows an ad to be personalized based on the mobile device to which it is to be provided. For example, instead of advertising “Fun for your phone”, the ad can be personalized to “Fun for your S710A” by the ad provider if desired by the associated advertiser.

In some embodiments, the winning ad provided to a publisher includes the data associated with the ad as well as a click URL associated with the ad. In some embodiments, if a user of a mobile device clicks on the click URL associated with an ad, the click goes directly through a server associated with the ad provider rather than through the publisher. This is useful, for example, for detecting click fraud because it allows the ad provider to verify that the IP address of the mobile device provided by the publisher with an ad request actually matches the IP address of the mobile device that responds to the ad. In some embodiments, the click URL associated with an ad includes an identifier associated with the bid of the ad, i.e. a bid identifier, so that when the URL is clicked, the ad provider can look-up where to redirect the user for that particular click as well as determine other information associated with the bid. In addition to a particular bid, a bid identifier may identify the publisher and/or the publisher site on which the ad was published so that the publisher can be compensated for publishing the ad. In some embodiments, the bid identifier maps to a revenue splitting scheme between the ad provider and the publisher so that appropriate payments can be transferred to the ad provider and the publisher from the associated advertiser when an ad is clicked. An ad may be monetized in any appropriate manner, e.g., an advertiser may need to pay a CPC (cost per click), CPA (cost per ad), CPP (cost per publication), etc.

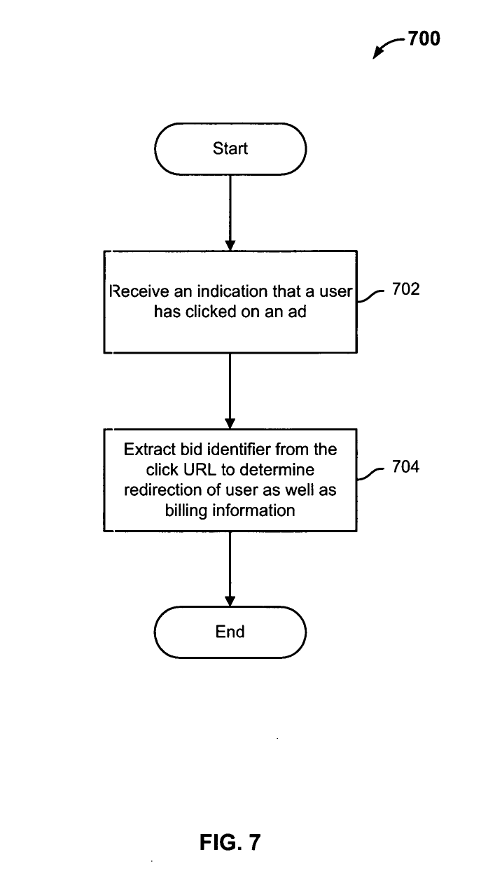

FIG. 7 illustrates an embodiment of a process for receiving a click on an ad provided by an ad provider. With respect to FIG. 1, for example, process 700 may be employed at an ad provider 106. Process 700 starts at 702 at which an indication that a user has clicked on an ad is received. At 704, the bid identifier associated with the clicked ad is extracted from the click URL associated with ad so that the user that clicked on the ad can be redirected to a page associated with the ad and so that billing information associated with the ad can be obtained. Process 700 subsequently ends.

In some embodiments, an ad provider charges an advertiser an extra fee per click (or per ad, per publication, etc.) in addition to the bid amount of an ad based on the extent to which the advertiser desires to target the ad. When an advertiser specifies targeting parameters associated with an ad, e.g., via an interface provided by the ad provider, dynamic feedback may be provided to the advertiser regarding the amount of extra targeting fees to be charged. For example, an advertiser may be able to select some targeting parameters without an extra targeting fee or surcharge; however, as the advertiser selects more and more targeting options, gradually higher targeting fees may be levied based on the extent of targeting selected by the advertiser.

In some embodiments, targeting fees are based at least in part on statistics of past click traffic, e.g., over a prescribed window or period of time, that are maintained and analyzed at the ad provider. For example, if an advertiser is targeting over 20% of the expected click traffic at in ad provider, no targeting fee may be charged; if the advertiser desires to target 10-20% of the expected click traffic, a $0.01 fee may be charged; if the advertiser desires to target 5-10% of the expected click traffic, a $0.02 fee may be charged; if the advertiser desires to target 1-5% of the expected click traffic, a $0.05 fee may be charged; and so on. Thus, an advertiser may be charged an extra fee or surcharge on top of the bid amount based on the extent of targeting. In some embodiments, the targeting fee is a per click fee. In some embodiments, the targeting fee is a flat fee. In some embodiments, the weightings of a group of matching ads from which a winning ad is to be elected are not based on any associated targeting fees or surcharges but only on the bid amounts. In some embodiments, the revenue obtained from a targeting fee is not shared or split with a publisher but rather is retained in its entirety by the ad provider, e.g., because the ad provider provides the targeting services. Alternatively, the revenue obtained from a targeting fee may be shared with a publisher.

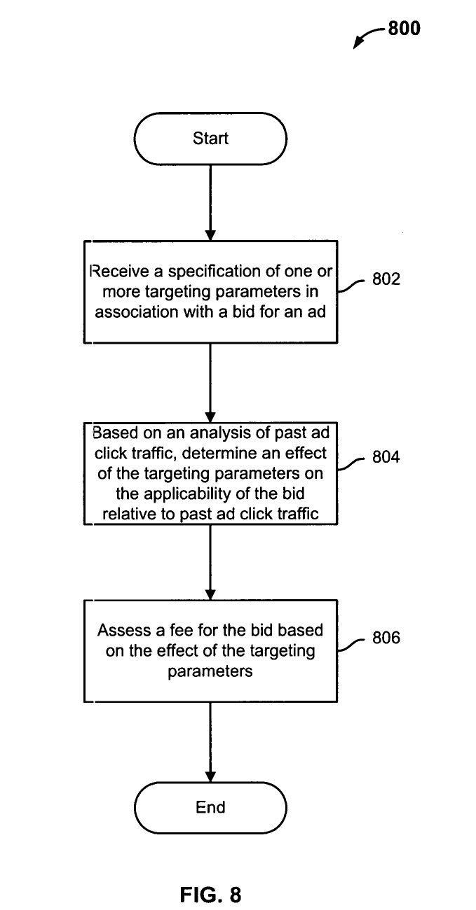

FIG. 8 illustrates an embodiment of a process for assessing a targeting fee for an ad. With respect to FIG. 1, for example, process 800 may be employed at an ad provider 106. Process 800 starts at 802 at which a specification of one or more targeting parameters is received in association with a bid for an ad. The targeting parameters may be associated with, for example, a site identifier, geographical region, carrier, device description, etc. At 804, based on an analysis of past ad click traffic, an effect of the targeting parameters specified at 802 on the applicability of the bid relative to past ad click traffic is determined. At 806, a fee is assessed for the bid based on the effect of the targeting parameters. Process 800 subsequently ends.

As described herein, a mobile device may request content from a publisher of the content. In response to the request from the mobile device, the publisher may provide the requested content as well as one or more ads. A publisher may obtain the one or more ads from an ad provider that distributes ads for publication on behalf of one or more advertisers. Information associated with the mobile device requesting content may be provided by the publisher to the ad provider so that a more targeted ad can be selected at the ad provider for the mobile device.

Although many of the given examples describe providing one or more ads to a mobile device with a mobile web site or web page requested by the mobile device, the techniques described herein may be similarly employed to provide one or more ads to a mobile device via other applications and platforms, such as games, tickers, etc.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for targeting an ad to a mobile device, comprising:
determining a set of information associated with a mobile device during a session when the mobile device is accessing a publisher; and
filtering a set of potential ads from which an ad is to be selected to be delivered to the mobile device along with content requested by the mobile device from the publisher based at least in part on the set of information.

2. A method as recited in claim 1, wherein the set of information includes one or more of:
an IP address of the mobile device, a user agent of the mobile device, an identifier associated with the content requested by the mobile device, a site identifier associated with a requested site or type of site, a phone number of the mobile device, an IMEI number of the mobile device, a carrier of the mobile device, a location of the mobile device, a device description associated with the mobile device, and information about a user of the mobile device.

3. A method as recited in claim 1, wherein one or more parameters included in the set of information are determined from one or more of: a request for content from the mobile device, an account of a user of the mobile device at the publisher, and a carrier associated with the mobile device.

4. A method as recited in claim 1, wherein one or more parameters included in the set of information are determined by a module of code at the publisher provided by an entity that delivers ads on behalf of advertisers.

5. A method as recited in claim 1, wherein filtering includes filtering the set of potential ads based at least in part on one or more parameters determined from one or more parameters included in the set of information.

6. A method as recited in claim 1, wherein the set of information includes an IP address of the mobile device and wherein a geographic region associated with the mobile device is determined from the IP address of the mobile device.

7. A method as recited in claim 1, wherein the set of information includes an IP address of the mobile device and wherein a carrier associated with the mobile device is determined from the IP address of the mobile device.

8. A method as recited in claim 1, wherein the set of information includes a user agent of the mobile device and wherein a device description associated with the mobile device is determined from the user agent of the mobile device.

9. A method as recited in claim 8, wherein the device description comprises one or more of:
a manufacturer of the mobile device, a model of the mobile device, a platform of the mobile device, a capability of the mobile device, and a feature supported by the mobile device.

10. A method as recited in claim 1, wherein the set of information includes information about a user of the mobile device obtained from a user account of the user with the publisher.

11. A method as recited in claim 1, wherein the set of information includes demographic information about a user of the mobile device.

12. A method as recited in claim 1, wherein demographic information about a user of the mobile device is inferred from one or more parameters included in the set of information.

13. A method as recited in claim 1, wherein filtering comprises matching one or more targeting parameters associated with an ad in the set of potential ads with corresponding parameters included in or determined from the set of information.

14. A method as recited in claim 1, wherein an ad is filtered out from the set of potential ads if a targeting parameter associated with the ad does not match a corresponding parameter included in or determined from the set of information.

15. A system for targeting an ad to a mobile device, comprising:
a module of code configured to determine a set of information associated with a mobile device during a session when the mobile device is accessing a publisher; and
a processor configured to filter a set of potential ads from which an ad is to be selected to be delivered to the mobile device along with content requested by the mobile device from the publisher based at least in part on the set of information.

16. A system as recited in claim 15, wherein to filter comprises to match one or more targeting parameters associated with an ad in the set of potential ads with corresponding parameters included in or determined from the set of information.

17. A system as recited in claim 15, wherein an ad is filtered out from the set of potential ads if a targeting parameter associated with the ad does not match a corresponding parameter included in or determined from the set of information.

18. A computer program product for targeting an ad to a mobile device, the computer program product being embodied in a computer readable medium and comprising computer instructions for:
determining a set of information associated with a mobile device during a session when the mobile device is accessing a publisher; and
filtering a set of potential ads from which an ad is to be selected to be delivered to the mobile device along with content requested by the mobile device from the publisher based at least in part on the set of information.

19. A computer program product as recited in claim 18, wherein filtering comprises matching one or more targeting parameters associated with an ad in the set of potential ads with corresponding parameters included in or determined from the set of information.

20. A computer program product as recited in claim 18, wherein an ad is filtered out from the set of potential ads if a targeting parameter associated with the ad does not match a corresponding parameter included in or determined from the set of information.
